(19) United States
(12) Patent Application Publication
(10) Pub. No.: US 2011/0093329 A1
(43) Pub. Date: Apr. 21, 2011

(54) MEDIA PREFERENCE CONSOLIDATION AND RECONCILIATION

(76) Inventors: Robert Bodor, Plymouth, MN (US); Aaron Weber, Orono, MN (US)

(21) Appl. No.: 12/903,830

(22) Filed: Oct. 13, 2010

Related U.S. Application Data
(60) Provisional application No. 61/251,191, filed on Oct. 13, 2009.

(51) Int. Cl. G06Q 30/00

(52) U.S. Cl. 705/14.42; 705/347; 705/14.49

(57) ABSTRACT

Media preference ratings are consolidated by receiving one or more first media item ratings for a user using a first rating system, and receiving one or more second media item ratings for the user from a third party using a second rating system. The one or more second media item ratings from the second rating system are translated into media item ratings in the first rating system, and the one or more media item ratings from the third party translated in the first rating system are combined with the one or more first media item ratings to form a composite media item rating set.

### CLAIM OF PRIORITY

This patent application claims the benefit of priority, under 35 U.S.C. §119(e), to U.S. Provisional Patent Application Ser. No. 61/251,191, entitled “Preference Consolidation and Distribution,” filed on Oct. 13, 2009, which is hereby incorporated by reference herein in its entirety.

### FIELD

The invention relates generally to media preference tracking, and more specifically in some embodiments to a media preference consolidation and reconciliation system and method.

### BACKGROUND

The rapid growth of the Internet and the proliferation of inexpensive digital media devices have led to significant changes in the way media is bought and sold. Online vendors provide music, movies, and other media for sale on websites such as Amazon, for rent on websites such as Netflix, and available for person-to-person sale on websites such as EBay. The media is often distributed in a variety of formats, such as a movie available for purchase or rental on a DVD or Blu-Ray disc, for purchase and download, or for streaming delivery to a computer, media appliance, or mobile device.

Internet companies that provide media such as music, books, and movies derive profit from their sales, and it is in their best interest to sell customers multiple items or subscriptions to provide an ongoing stream of profits. Netflix, for example, provides a subscription service to customers enabling them to rent or stream movies, and profits as long as subscribers continue to find enough new movies to watch to remain a subscriber. Pandora provides streaming audio in a customized music station format based on a customer's music preferences, deriving profit from either subscriptions or from advertising placed in limited free services. Amazon derives the majority of its profits from sale of physical media, and increases its profit from providing a customer with media recommendations similar to items that a customer has already purchased.

These media recommendations are typically made by employing a recommendation engine to identify media that is similar to other media in which a customer has shown an interest in, such as by purchasing, renting, or rating other media. Similarly, advertising for media can tailored to individual users by predicting or estimating what media individuals are likely to enjoy. Recommendation engines typically use knowledge regarding an individual's past media preferences to make these predictions, such as by using sales histories, advertising click-through histories, or user ratings of media as are common on sites such as Netflix and Flixster.

Because a user typically interacts with media in a variety of environments, such as through advertising, through purchasing from sites such as Amazon, from renting via services such as Netflix, and from rating using sites like Flixster, an active online media consumer typically has created a significant amount of media preference information over time. It is therefore desirable to best make use of the variety of media preference information created by a user, to better perform tasks such as media recommendation and targeted advertising.

### SUMMARY

One example embodiment of the invention comprises a system and method for consolidating media preference ratings. Media preference ratings are consolidated by receiving one or more first media item ratings for a user using a first rating system, and receiving one or more second media item ratings for the user from a third party using a second rating system. The one or more second media item ratings from the second rating system are translated into media item ratings in the first rating system, and the one or more media item ratings from the third party translated in the first rating system are combined with the one or more first media item ratings to form a composite media item rating set.

### BRIEF DESCRIPTION OF THE FIGURES

FIG. 1 shows an example screen image prompting a user to link a media preference consolidation service with one or more other services, consistent with an example embodiment of the invention.

FIG. 2 shows an example screen having user media ratings based on imported and manually entered ratings, consistent with an example embodiment of the invention.

FIG. 3 shows an example screen having recommendations for a user based on imported and manually entered preferences, consistent with an example embodiment of the invention.

FIG. 4 shows examples of importing, reconciling, consolidating, and distributing user media preference information, consistent with an example embodiment of the invention.

FIG. 5 shows an example authorization process using OAuth, consistent with the prior art.

FIG. 6 shows an example authorization process in which the initiating party is responsible for token generation, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention.

Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to describe these example embodiments. Features or elements shown in various examples described herein can be combined in ways other than shown in the examples, and any such combination is explicitly contemplated to be within the scope of the invention. The following detailed description does not, therefore, limit the scope of the invention, which is defined only by the appended claims.

Tracking media preferences of consumers is becoming commonplace as more types of businesses rely on knowledge of consumers to provide them with advertising, recommendations, and other media tailored to individual consumers. Advertisers rely on knowledge of a user to deliver advertising that fits a user's interests and preferences, just as media rental or sales companies such as Netflix and Amazon rely on knowledge of a customer's media preferences to recommend additional media for rental or purchase. Recommendation of media such as books, movies, or music that a customer is likely to enjoy can improve the sales of websites such as Amazon, improve the subscription rate and duration of rental services such as Netflix, and help the utilization rate of advertising-driven services such as Pandora. Although each of these examples derive their revenue from providing media in different ways, they all benefit from providing good quality recommendations to customers regarding potential media purchases, rentals, or other use.

Similarly, knowledge of a user's preferences and interests can help target advertising that is relevant to a particular user, such as advertising horror movies only to those who have shown an interest in horror films, targeting country music advertising toward those who prefer country to rap or pop music, and presenting book advertising to those who have shown a preference for similar books.

Tracking media preferences such as past purchases, rentals, or ratings of media enables media recommendations such as these to be made via a recommendation engine, which identifies media that is similar to other media in which a customer has shown an interest in, such as by purchasing, renting, or rating other media. Some websites, such as Netflix, ask a user to rank dozens of movies upon enrollment so that the recommendation engine can provide meaningful results. Other websites such as Amazon rely more upon a customer's purchase history and items viewed during shopping. Pandora differs from these approaches in that a user can rate relatively few pieces of media, and is provided a broad range of potentially similar media based on domain knowledge of the selected media items.

Because the number of items purchased or the length of a subscription are related to the value a provider receives in continued interaction with a customer, it is in the provider's best interest to provide media recommendations that are accurate and well-suited to its customers. Similarly, presentation of advertising that is tailored to a user increases a user's interest in the advertising, increases the likelihood of a click-through or revenue generating transaction for the advertiser, and improves the odds of a user electing to view an advertised piece of media.

Because a user typically interacts with media in a variety of environments, such as through advertising, through purchasing from sites such as Amazon, from renting via services such as Netflix, and from rating using sites like Flixster, an active online media consumer typically has created a significant amount of media preference information over time. But, because user preferences are often distributed over a large number of vendors, service providers, and ratings sites, the amount of created user preference information available to any specific provider or application can be greatly limited. It is therefore desirable to best make use of the variety of media preference information created by a user, to better perform tasks such as media recommendation and targeted advertising.

One example embodiment of the invention therefore provides media preference consolidation and reconciliation, enabling use of preference information from multiple sources and in multiple formats to be used together in producing better quality media recommendation. This comprises combining preferences from multiple sources in some embodiments, and further embodiments provide additional functions such as reconciling conflicting ratings or normalizing ratings between different rating systems.

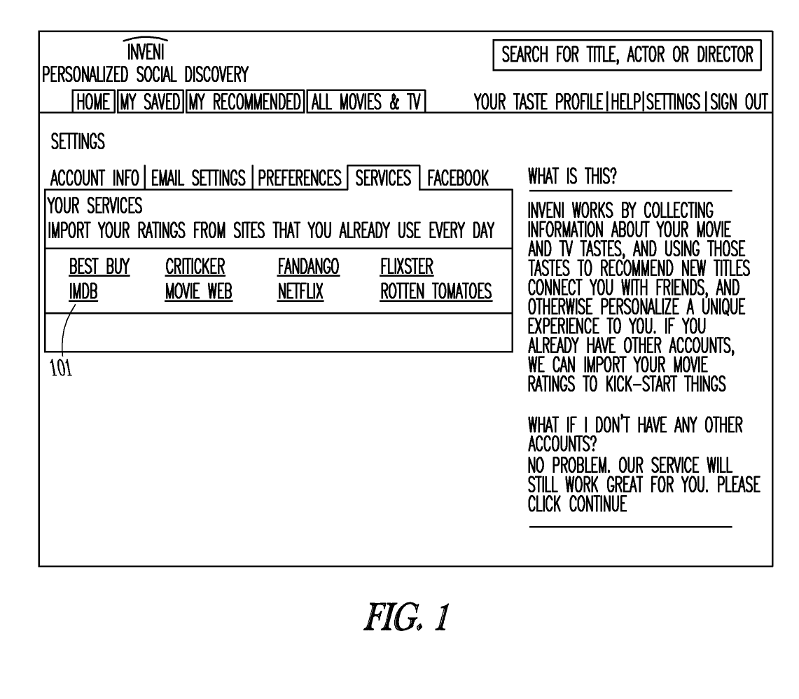

In one such example system, a user logs on to a media preference management website, such as Inveni.com. The user is presented with a settings screen enabling the user to selectively import data from a variety of media preference tracking websites, such as Netflix, IMDB, Flixster, and Rotten Tomatoes, as shown at 101 of FIG. 1. The user selects one or more of the third-party providers from which to import data, such as importing purchasing history and ratings from Amazon, or importing movie ratings from Netflix. For some websites, the user will be required to provide information such as a user ID or authenticate through OAuth or an equivalent authentication service to enable the media preference management service to collect data from certain third-party media services.

The Inveni website in this example then imports the media preference data from the selected third-party websites, and combines it with other media rating data in the user's Inveni account. By doing this, media preference information from a variety of sources can be added to media preference information generated directly on the Inveni site, and be used to provide better media recommendations to the user. The information in a further embodiment is provided to third party affiliates, such as sending the media data to Amazon so that it may make better movie purchase recommendations to the user, or to an advertising service such as Google Ads so that media advertising presented to the user is better tailored to the user's interests.

In a further embodiment, Inveni serves as a type of central arbiter or repository for ratings, such that when a user has elected to link various accounts such as Netflix or Rotten Tomatoes to Inveni, the Inveni site receives media rating from a variety of other websites or services, consolidates the rating information, and distributes the consolidated information back out to one or more of the other websites or services. This enables third-party services such as Netflix or Amazon to benefit from media ratings originally provided on each others' sites, as well as benefitting from media ratings provided via other services such as Flixster.

Exchange of media preference data is performed through some service providers' provide interfaces, while in other embodiments third party systems will use an Application Programming Interface (API) provided by the Inveni media preference service. The Inveni media preference service stores the most recent rating from each participating web site, and stores an Inveni consolidated preference score for each media item rated on any associated site or service.

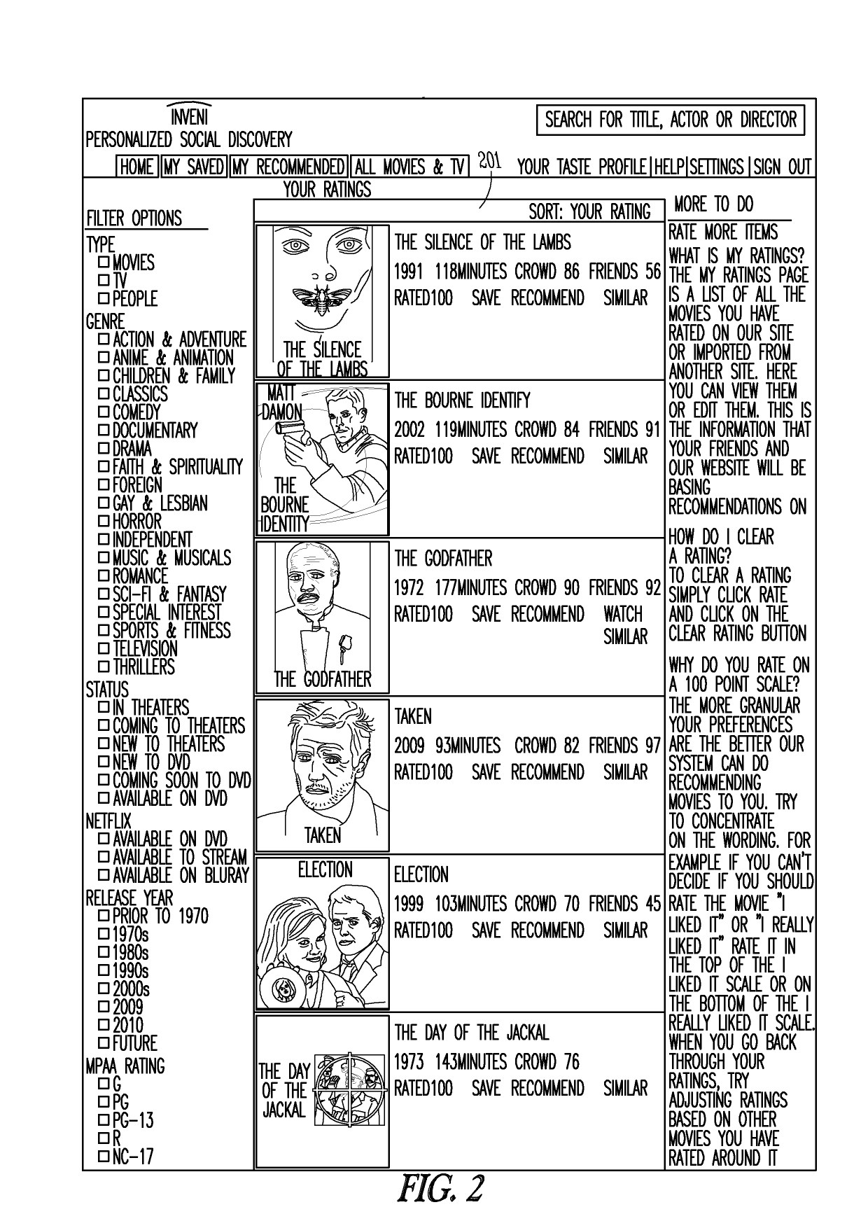

The Inveni consolidated ratings are also visible to the user, and can be viewed, changed, or created through web pages such as that shown in FIG. 2. Here, a series of movie ratings are presented, sorted in order of the user rating. The movies shown on the first screen are therefore all movies that have been rated “100” out of 100 points by the user, while movies rated lower will be presented on following screens.

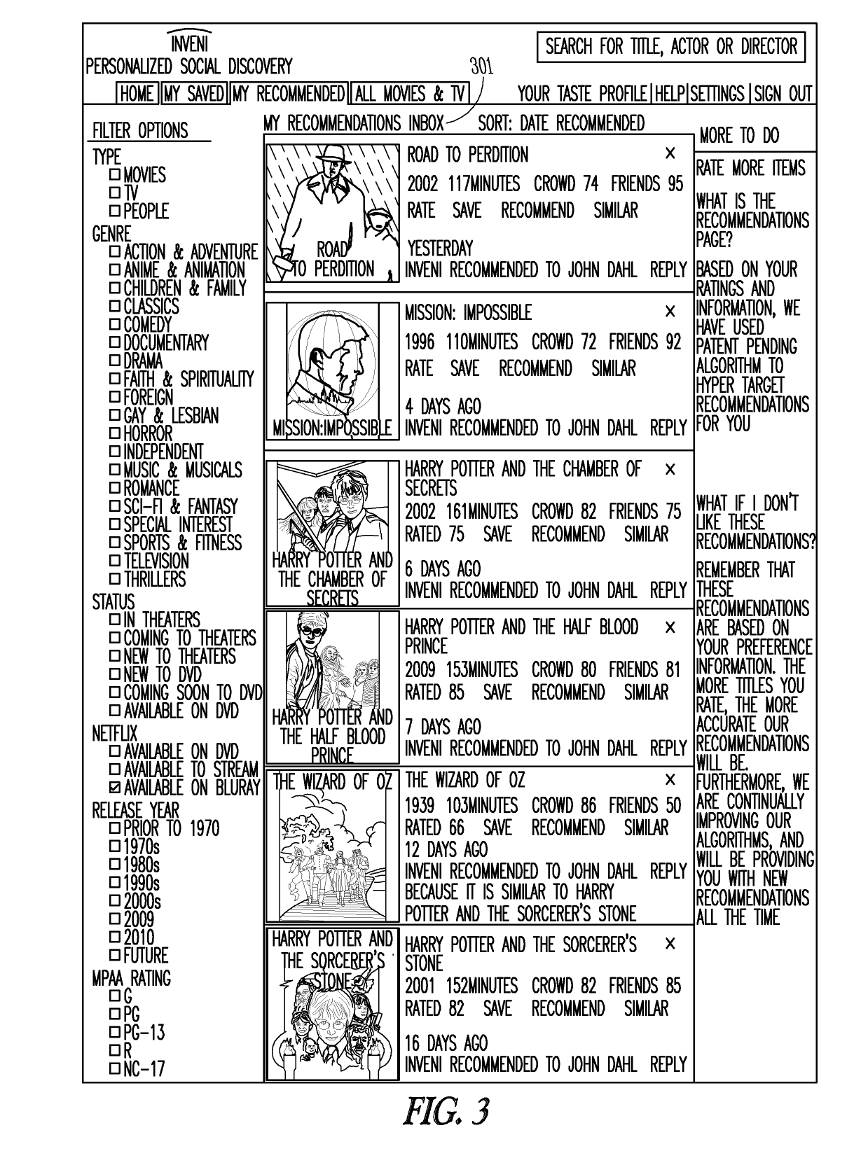

The user Inveni service presented as an example here provides a variety of services directly to the user, including recommendations. FIG. 3 shows an example screen having recommendations for a user based on imported and manually entered preferences, consistent with an example embodiment of the invention. Here, several movies are presented to the user in order of the user's likely rating of the movie, based on the user's known preference information. The user can rate movies that he has already seen, save movies to a list or queue, select a movie to buy from an affiliated vendor such as Amazon or rent from a vendor such as Netflix, or perform other such functions.

Simply importing and distributing rating information is not as simple as managing a database of rating information, as different service providers and vendors use significantly different ratings systems. Inveni in this example permits ratings from 0-100, resulting in 101 distinct possible rating levels. Netflix, however, only allows a user to rate something from 0-5 stars, giving users only six distinct rating levels from which to choose. Ratings imported from Netflix to Inveni must therefore be mapped to Inveni's rating system, such as by mapping zero stars to an Inveni rating score of 0, one star to an Inveni score of 20, two stars to a score of 40, three stars to a score of 60, four stars to a score of 80, and five stars to an Inveni rating score of 100.

Rotten Tomatoes uses a five star rating system similar to Netflix, but permits half star increments in ratings with a half star rating the lowest permissible rating. This can therefore be mapped in one embodiment using an Inveni rating of 10 as the lowest rating, with each additional half star counting for another 10 rating points. In an alternate embodiment, a half star on Rotten Tomatoes corresponds to a zero in Inveni's rating system, so that the lowest possible and highest possible scores correspond. Each additional half star would then count for approximately 10/9 or 11.1, so that corresponding Inveni rating scores would be 0, 11, 22, 33, 44, 56, 67, 78, 89, and 100.

In further embodiments, users may view some rating systems differently than others, such that direct proportional translations of ratings do not directly correspond between systems. For example, a user may rate most movies between zero and five stars on Netflix, but rate the same movies varying over 60-100% on Inveni. The media consolidation and reconciliation process in some further embodiments will therefore look for variation in movie ratings between services, such as higher or lower mean ratings and higher or lower distributions, by observing characteristics such as differing ratings for the same media items or differences in mean rating value and distribution of ratings. Importation of ratings from external services can then use such information to normalize ratings during importation, reducing any media item rating bias that may occur as a result of using one system rather than another.

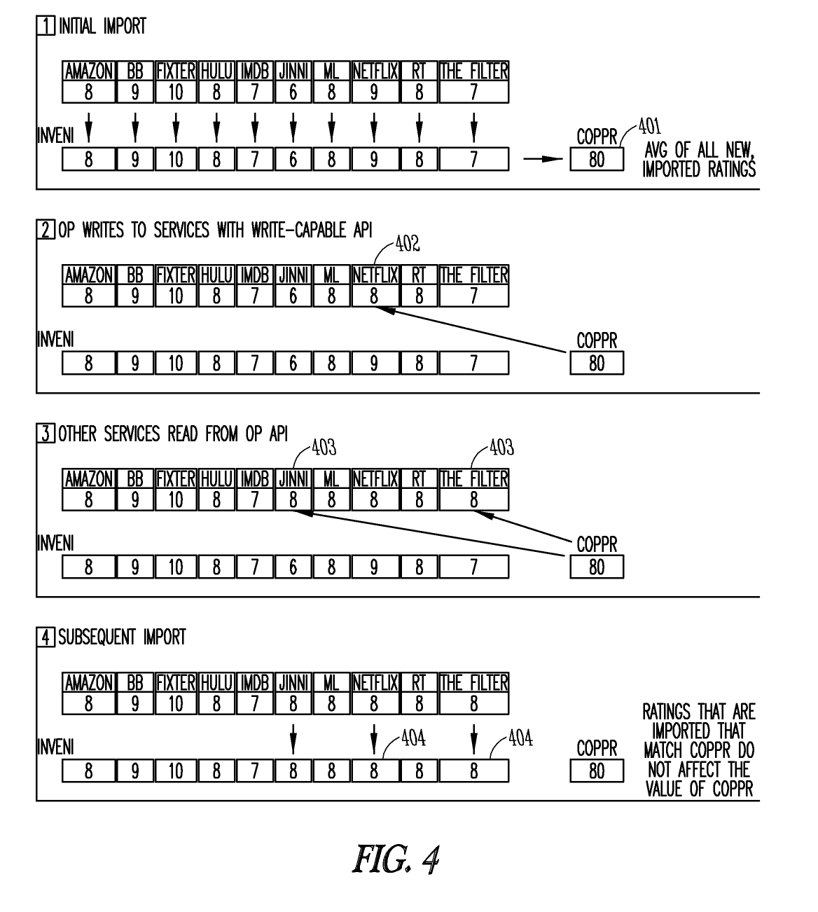

These same rating translations can be used to push Inveni ratings back out to services that are associated with Inveni, so that all participating websites and services have a more complete and up-to-date record of a user's media preferences. This is illustrated in more detail in FIG. 4, which shows preference consolidation and distribution, consistent with an example embodiment of the invention. At 401, rating information from ten different media rating websites is transferred to Inveni, and is averaged or otherwise processed to derive an Inveni media rating of 80. This rating is pushed back to services associated with Inveni that can are write-capable, or that can be updated by external services. In this example, the Netflix rating is changed from a 9 to an 8, corresponding to four stars using Netflix's rating system. At 403, two additional services update themselves by querying Inveni for ratings updates, reading Inveni information using Inveni's API.

When these updated ratings of “8” are stored to these three web services, their ratings propagate back to Inveni as shown at 404, but their ratings do not affect the Inveni rating as they are consistent with the current Inveni media rating of 80. However, if new information is received after the initial import of data shown in FIG. 4, it is in some examples assumed that the newly updated data is the most recent and best estimate of the user's preference, and so the changed rating is used alone to establish the Inveni media rating score and is propagated back to participating websites and services such as is shown at 402 and 403. Similarly, the Inveni system in an embodiment alternate to that shown in FIG. 4 will use the most recent rating or ratings to establish an Inveni media rating for each media object upon initial importation of external service data, rather than use an average of all available ratings.

If a user makes other modifications to a media item, such as deleting or setting a media item as “private”, this change is also imported into some example embodiments of a media rating system such as the Inveni examples presented here, and propagated to associated services or websites. For example, if a user deletes a rating for a movie on Netfilx, it is assumed that the rating is incorrect, such as the user mistaking one movie for another or the user not having a clear opinion regarding the movie. This deletion then propagates to those associated websites allowing deletion, and is optionally given an average score or left with the previous Inveni rating on sites not allowing deletion. It will remain “deleted” on Inveni's web site until an updated score is received in Inveni, either through direct rating or through imported rating, at which time the new score will be propagated to participating websites.

Similarly, a user may wish to mark certain movies as “private”, removing them from being made a part of a public profile, shared with friends, posted to social media sites such as Facebook, or otherwise made public. A user may also elect to have movies having or exceeding certain ratings automatically private, such as not sharing media with an NC-17, Mature, or “Unrated” rating. If a user elects to make a media item private, the privacy election is propagated to participating media sites, such as by pushing the privacy setting as shown at 402 or allowing remote services to update via an Inveni API as shown at 403. In a further example, rating scores for private media are deleted from or not propagated to sites that don't include a “private” media state option, reducing the chances of privately rated media becoming inadvertently public.

If multiple new ratings are received at approximately the same time, such as a user reviewing a movie on multiple websites or rating services the same day after watching a movie, the new ratings are averaged in one embodiment to estimate the most accurate representation of the user's opinion regarding the media item. In alternate embodiments, the newest, most detailed, or other such selection criteria are used to select one or a subset of the scores to generate an Inveni score update, which is then propagated to the other associated websites and rating services.

Media items in the examples presented above have included primarily movies, but in other embodiments books, music, and other such media are also rated. In still further embodiments, other merchandise such as appliances, clothing, or the like may be rated, as tastes and preferences may be useful in recommending additional appliances or clothing.

Rated items such as media are identified using identifying information likely to be common to the media object across multiple websites, such as a UPS code, ISBN number, or other such identifier. Returning to movies as an example, other item characteristics such as title, actors, release year, and the like may be used to identify or confirm the identity of a particular movie. For example, simply searching for movies titled “Superman” yields a movie result, but examination of other criteria shows that separate versions were released in 1978 starring Christopher Reeve, in 1952 starring George Reeves, and in 2006 starring Brandon Routh. Examination of these characteristics enables the Inveni system to distinguish between these three movies, and establish and track different ratings for each movie.

The media matching system in some embodiments uses a “fuzzy” or weighted system to determine whether two media items are the same or distinct, enabling the media rating system to account for minor variations in description of a movie. For example, “Star Wars Episode 2: Attack of the Clones” is clearly the same movie as “Star Wars Ep. II—The Attack of the Clones”, even though their titles vary somewhat. In this example, a fuzzy match can be estimated by comparing the titles, and the movies can be determined to be the same media by looking at secondary characteristics such as release date, actors, and the like. In a further embodiment, close or uncertain matches can be flagged for user intervention, where user or administrator input can be used to determine whether two instances of a media item describe the same or different media items. This determination can then be stored and the item descriptions associated with one another, so that re-matching the same media descriptions to one another is not necessary.

Media matching can similarly help determine whether media items having separate identities such as different UPC codes and slightly varying titles are different movies, for example, or are simply director's cuts, Blu-Ray and DVD versions, and other such versions of the same media item that should be treated as the same media item for purposes of rating. In this way, multiple media items from even a single source, such as Amazon, may be considered the same media item for purposes of rating and recommendation.

Obtaining media preferences from other websites or services and sharing reconciled and consolidated media preferences with these other websites will typically require some type of user identification or authentication. Because users and other service providers may be unwilling to share passwords with an external service such as Inveni, systems other than simply providing logon credentials to a media preference management service such as the Inveni examples presented here are desirable. Providing logon credentials typically enables a third party such as Inveni to make purchases and perform a variety of other functions the user may not be willing to allow, so requiring a password may dissuade a user from participating in a third-party preference management service. Further, if a user updates a password on services such as Amazon or Netflix, the user is not likely to promptly change the password on a media preference site that makes use of the password to manage media preferences.

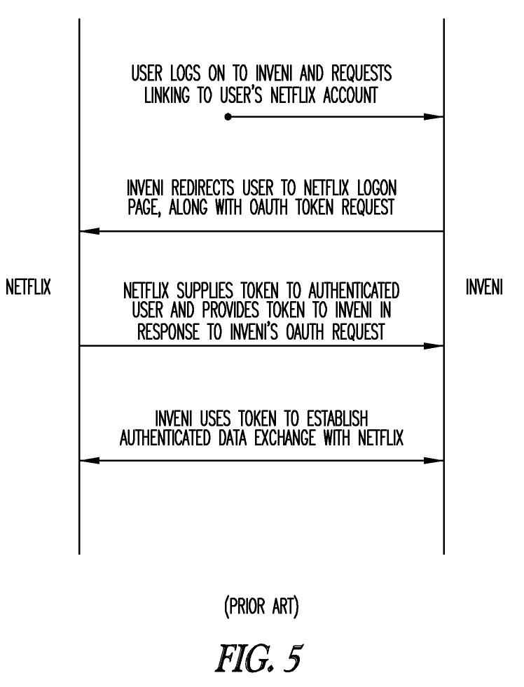

For reasons such as these, an authentication system such as OAuth is employed in some embodiments. Referring to FIG. 5, OAuth works by a user logging on to a website such as Inveni, and requesting that a third party such as Netflix provide Inveni after the user authenticates himself to Netflix. The token provided by Netflix is associated with a certain set of rights, such as the right to change preferences and queue information, but not to access or change subscription or billing information. In operation, a user logs on to Inveni and expresses a desire to link the Inveni account with Netflix, as shown at 501. The Inveni service generates an OAuth request sent to Netflix, and redirects the user to an associated Netflix page prompting the user to log on or supply other such credentials at 502. Once the user is logged on to Netflix, an OAuth token is generated, associated with the rights the user wishes to convey to Inveni. The token is provided back to Inveni at 503, and the user is redirected back to the Inveni page. Inveni then uses the token to authenticate itself to Netflix, and exchanges data with Netflix at 504. The connection between Inveni and Netflix may be secured, to help ensure the privacy of data exchanged between the two providers Netflix and Inveni.

This system works, but requires that the user's request be originated by Inveni and requires a logon at Netflix's site to ensure that the user has authenticated himself to both parties. Further, the OAuth process requires that the service that initiates the request is different than the service that generates the shared ID or token. This can make partnering with third party services somewhat more challenging, in that it requires that third parties such as Netflix install and support an infrastructure operable to generate the shared tokens.

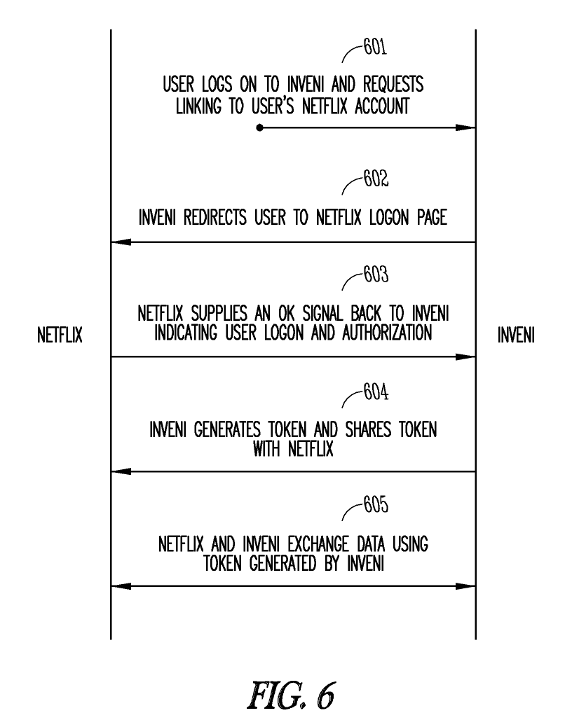

Some example embodiments of the invention avoid this limitation by providing an authentication system as shown in FIG. 6. Here, the user logs on to

Inveni and requests that his account be linked with a Netflix account at 601. The user is redirected to Netflix at 602, and logs in to the Netflix account to establish ownership of the account. Netflix supplies an “OK” signal as a result of a successful login back to Inveni at 603, and Inveni generates a token at 604. This token is then shared with Netflix, and either party can use the token to exchange authorized data with the other party at 605.

This system has the advantage that the party initiating the request is responsible for generating the token and managing the setup process, reducing the burden on the third party (Netflix in this example). Because there is no OAuth service hosting requirement, such a system is likely to have greater appeal to third party services that do not wish to make a significant resource investment in sharing information with other service providers.

The examples presented here have shown how a media preference service can be linked to other services such as web retailers, media rating and recommendation sites, rental services, and other such providers to establish a more complete and accurate user media preference record. This record can then be used to provide media recommendations, to provide targeted advertising, or to provide more accurate media preference information back to participating third party services to improve the quality of service provided to the user.

Although specific embodiments have been illustrated and described herein, any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A method of consolidating media preference ratings, comprising:
receiving one or more first media item ratings for a user using a first rating system;
receiving one or more second media item ratings for the user from a third party using a second rating system;
translating the one or more second media item ratings from the second rating system into media item ratings in the first rating system; and
combining the one or more media item ratings from the third party translated in the first rating system with the one or more first media item ratings to form a composite media item rating set.

2. The method of consolidating media preference ratings of claim 1, wherein the one or more first media item ratings are obtained from one or more of a second third-party vendor, or direct user input.

3. The method of consolidating media preference ratings of claim 1, further comprising normalizing the one or more second media item ratings based on at least one of common item rating and rating distribution between the second media item ratings and the first media item ratings.

4. The method of consolidating media preference ratings of claim 1, wherein conflicting second media item ratings and first media item ratings are reconciled using at least one of the dates of the ratings, granularity of the ratings, distribution of the ratings, and mathematical characteristics of the ratings.

5. The method of consolidating media preference ratings of claim 1, further comprising distributing the composite media item rating set to at least one third party.

6. The method of consolidating media preference ratings of claim 5, further comprising tracking a privacy setting for one or more of media items in the composite media item rating set, and at least one of restricting distribution of ratings for media items marked as private or distributing privacy setting information with media item ratings marked private.

7. The method of consolidating media preference ratings of claim 5, wherein distributing the composite media item rating set to at least one third party comprises overwriting media item ratings from one or more third party that conflict with media item ratings from the composite media item rating set with the media item rating from the composite media item rating set.

8. The method of consolidating media preference ratings of claim 1, wherein the composite media item rating set is maintained by a media item rating service which is further operable to provide media item recommendations to the user based on the composite media item rating set.

9. The method of consolidating media preference ratings of claim 1, wherein the composite media item rating set is maintained by a media item rating service which is further operable to provide a predicted media item rating for the user for unrated media items based on the composite media item rating set.

10. The method of consolidating media preference ratings of claim 9, further comprising providing one or more of the predicted media item ratings to an advertiser regarding a media item advertised by the advertiser.

11. The method of consolidating media preference ratings of claim 9, further comprising indicating to an advertiser which of a plurality of media items has a highest predicted media item rating for a user.

12. The method of consolidating media preference ratings of claim 1, wherein receiving one or more second media item ratings for the user from a third party comprises:
receiving a request from the user to link to an account with the third party;
generating and providing the third party with a shared token in response to the user successfully authenticating ownership of an account with the third party; and
using the shared token to exchange media item preference information with the third party.

13. A media preference rating consolidation system, comprising:
a rating interface module operable to receive one or more first media item ratings for a user using a first rating system, and receive one or more second media item ratings for the user from a third party using a second rating system;
a media translation module operable to translate the one or more second media item ratings from the second rating system into media item ratings in the first rating system, and combine the one or more media item ratings from the third party translated in the first rating system with the one or more first media item ratings to form a composite media item rating set.

14. The media preference rating consolidation system of claim 13, wherein the one or more first media item ratings are received from one or more of a second third-party vendor, or direct user input.

15. The media preference rating consolidation system of claim 13, the media translation module further operable to normalize the one or more second media item ratings based on at least one of common item rating and rating distribution between the second media item ratings and the first media item ratings.

16. The media preference rating consolidation system of claim 13, the media translation module further operable to reconcile conflicting second media item ratings and first media item ratings by using at least one of the dates of the ratings, granularity of the ratings, distribution of the ratings, and mathematical characteristics of the ratings.

17. The media preference rating consolidation system of claim 13, the rating interface module further operable to distribute the composite media item rating set to at least one third party.

18. The media preference rating consolidation system of claim 17, the media translation module further operable to track a privacy setting for one or more of media items in the composite media item rating set, and at least one of restrict distribution of ratings for media items marked as private or distribute privacy setting information with media item ratings marked private.

19. The media preference rating consolidation system of claim 17, wherein distributing the composite media item rating set to at least one third party comprises overwriting media item ratings from one or more third party that conflict with media item ratings from the composite media item rating set with the media item rating from the composite media item rating set.

20. The media preference rating consolidation system of claim 13, further comprising a recommendation module that is operable to provide media item recommendations to the user based on the composite media item rating set.

21. The media preference rating consolidation system of claim 13, further comprising a media rating estimation module that is operable to provide a predicted media item rating for the user for unrated media items based on the composite media item rating set.

22. The media preference rating consolidation system of claim 21, the media rating estimation module further operable to provide one or more of the predicted media item ratings to an advertiser regarding a media item advertised by the advertiser.

23. The media preference rating consolidation system of claim 21, the media rating estimation module further operable to indicate to an advertiser which of a plurality of media items has a highest predicted media item rating for a user.

24. The media preference rating consolidation system of claim 13, wherein receiving one or more second media item ratings for the user from a third party comprises:
receiving a request from the user to link to an account with the third party;
generating and providing the third party with a shared token in response to the user successfully authenticating ownership of an account with the third party; and
using the shared token to exchange media item preference information with the third party.
